(19) United States
(12) Patent Application Publication
(10) Pub. No.: US 2026/0328471 A1
(43) Pub. Date: Oct. 22, 2026

(54) REFRIGERATOR

(71) Applicants: HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Zhuohua JIANG, HEFEI (CN); Bo PENG, HEFEI (CN); Xiuliang FU, HEFEI (CN); Yafei ZHU, HEFEI (CN); Yerui FENG, HEFEI (CN); Bing SHI, HEFEI (CN); Jinguo YUAN, HEFEI (CN); Chuandong WANG, HEFEI (CN); Shenghao QI, HEFEI (CN); Ronghai CHEN, HEFEI (CN)

(21) Appl. No.: 19/112,258

(22) PCT Filed: Jun. 27, 2023
(86) PCT No.: PCT/CN2023/102678

§ 371 Date: Mar. 16, 2025

(30) Foreign Application Priority Data
Sep. 22, 2022 (CN) 202211145444.5

(51) Int. Cl. F25D 23/02; E05F 15/616

(52) U.S. Cl. CPC F25D 23/028; E05F 15/616; E05Y 2201/21; E05Y 2201/216; E05Y 2201/224; E05Y 2201/71; E05Y 2900/31

(57) ABSTRACT

A refrigerator including a box body, a door body that is rotatably disposed on the box body, and a door opening and closing device that is connected to the box body and the door body. The door opening and closing device includes: a base, a driving mechanism, a clutch mechanism, a clutch-ejection-push assembly, a linkage gear and a door rotation mechanism. The driving mechanism includes a driver fixedly disposed on the base and an output gear connected to the driver. The clutch mechanism includes a first transmission assembly and a transmission structure which are separably connected. The first transmission assembly is connected to the output gear. The clutch-ejection-push assembly pushes the transmission structure to be connected to or separated from the first transmission assembly.

### CROSS-REFERENCES TO RELATED APPLICATIONS

The present disclosure is a national phase application of International Application No. PCT/CN2023/102678, filed Jun. 27, 2023, which claims priority to the Chinese patent application No. 202211145444.5, filed on Sep. 20, 2022, the entire contents of which are incorporated herein by reference.

### FIELD

The disclosure belongs to a field of electrical apparatus, and in particular relates to a refrigerator.

### BACKGROUND

With an improvement of living standards, electrical apparatuses such as refrigerators and the like have become widely used in lives of people. In order to maintain a sealing performance of the refrigerator, an adsorption structure is usually disposed between a box body and a door body of the electrical apparatuses, or a negative pressure is maintained inside relative to outside of the electrical apparatuses to stably fix the door body onto the box body. Although a related performance of the refrigerator is improved in this way, a difficulty of opening the door body is also increased to a certain extent. Since a larger force is usually required to open the door body of the refrigerator, it is inconvenient to use.

### SUMMARY

A refrigerator is provided according to one or more embodiments of the disclosure, which is intended to at least solve a problem of inconvenience in a door-opening operation of a refrigerator to a certain extent.

According to one or more embodiments of the disclosure, a refrigerator is provided, which may include: a box body, a door body rotatably disposed on the box body, and a door opening and closing device connected onto the box body and the door body. The door opening and closing device may include: a base; a driving mechanism comprising a driver fixedly that is disposed on the base and an output gear that is connected to the driver; a clutch mechanism comprising a first transmission assembly and a transmission structure which are separably connected, wherein the first transmission assembly is connected to the output gear, and the first transmission assembly and the output gear are disposed side by side on the base; a clutch-ejection-push assembly pushing the transmission structure to be connected to or separated from the first transmission assembly; a linkage gear rotatably disposed on the base and connected to the transmission structure, wherein the linkage gear and the transmission structure are disposed side by side; and a door rotation mechanism connected to the linkage gear and the door body, to drive the door body to rotate under a driving of the linkage gear.

### BRIEF DESCRIPTION OF THE DRAWINGS

In order to more clearly illustrate one or more embodiments of the disclosure, the following briefly introduces the accompanying drawings required for describing the embodiments. The accompanying drawings in the following description only illustrate one or more embodiments of the disclosure, and other accompanying drawings can also be obtained based on these accompanying drawings.

FIG. 1 shows a schematic assembly structural diagram of a refrigerator according to an embodiment of the disclosure;

FIG. 2 shows an exploded view of a first structure of a clutch mechanism of the refrigerator in FIG. 1;

FIG. 3 shows an exploded view of a second structure of the clutch mechanism of the refrigerator in FIG. 1;

FIG. 4 shows an exploded view of the clutch mechanism of the refrigerator in FIG. 2 from another viewing angle;

FIG. 5 shows a schematic structural diagram of a first transmission assembly of the clutch mechanism of the refrigerator in FIG. 1;

FIG. 6 shows a schematic structural diagram of a second transmission assembly of the clutch mechanism of the refrigerator in FIG. 1;

FIG. 7 shows a schematic structural diagram of a transmission connection assembly of the clutch mechanism of the refrigerator in FIG. 1;

FIG. 8 shows a schematic structural diagram of an ejection-push sleeve of a clutch-ejection-push assembly of the clutch mechanism of the refrigerator in FIG. 1;

FIG. 9 shows a schematic structural diagram of a push rod of the clutch-ejection-push assembly of the clutch mechanism of the refrigerator in FIG. 1;

FIG. 10 shows a schematic assembly structural diagram of the clutch-ejection-push assembly of the clutch mechanism of the refrigerator in FIG. 1;

FIG. 11 shows a schematic assembly diagram of the ejection-push sleeve of the clutch mechanism of the refrigerator in FIG. 1;

FIG. 12 shows a schematic structural diagram of an anti-rotation mechanism of the clutch mechanism of the refrigerator in FIG. 1;

FIG. 13 shows a schematic structural diagram of the refrigerator in FIG. 1 in a suspension condition;

FIG. 14 shows a schematic diagram of a first structure of a suspension mechanism of the refrigerator in FIG. 1;

FIG. 15 is a schematic structural diagram of a linkage gear of the refrigerator in FIG. 1;

FIG. 16 is a schematic diagram showing a cooperation of a suspension member and a push-ejection member of the refrigerator in FIG. 1;

FIG. 17 shows a schematic structural diagram of a suspension limit slide groove of the refrigerator in FIG. 1;

FIG. 18 is a schematic diagram showing a cooperation of the suspension member and the suspension limit slide groove of the refrigerator in FIG. 1;

FIG. 19 shows a schematic structural diagram of the door ejection portion of the door opening and closing device of the refrigerator in FIG. 1;

FIG. 20 is another schematic structural diagram of a door ejection mechanism of the door opening and closing device of the refrigerator in FIG. 1;

FIG. 21 shows a schematic diagram of a second structure of the suspension mechanism of the door opening and closing device of the refrigerator in FIG. 1;

In the accompanying drawings, corresponding relationships between reference signs and component names are as follows:
12, box body; 13, door body;
100, driving mechanism; 110, driver; 120, output gear;
200, clutch mechanism; 210, first transmission assembly; 211, engaging groove; 212, first transmission gear; 220, second transmission assembly; 221, engaging hole; 222, second transmission gear; 230, transmission connection assembly; 231, connecting end; 2311, connecting arm; 232, ejection-push end; 240, clutch-ejection-push assembly; 241, ejection-push sleeve; 2411, push-ejection portion; 2412, shaft sleeve portion; 2413, first ejection-push surface; 2414, anti-rotation slot; 242, push rod; 2421, second ejection-push surface; 2422, push arm; 2423, connecting portion; 243, linear driver; 244, shock-absorbing pad; 250, separation assembly; 251, first separation member; 252, second separation member; 253, elastic reset member; 260, stop assembly; 261, connecting member; 262, lock member; 263, stop member; 270, transmission structure;
300, linkage gear; 310, rotation center; 320, limit structure, 330, door ejection portion;
400, door rotation mechanism; 410, front connecting rod; 420, rear connecting rod; 431, first connection point; 432, second connection point; 433, third connection point;
500, door ejection mechanism; 510, door ejection member; 520, abutting-holding portion;
600, suspension mechanism; 610, suspension member; 611, ejecting-abutting portion; 612, push-ejection limit slot; 620, push-ejection member; 630, suspension-connection member; 640, suspension-limit groove;
800, angle acquisition unit;
900, base; 906, suspension limit slide groove; 907, limit boss; 908, support groove; 909, boss portion; 920, common rotating shaft; 921, support column; 922, rotating shaft column; 923, fastening through hole; 930, anti-rotation mechanism; 931, anti-rotation rib.

### DETAILED DESCRIPTION OF THE DISCLOSURE

The embodiments of the disclosure will be clearly and completely described below with reference to the accompanying drawings. The described embodiments are only some embodiments, rather than all embodiments of the disclosure.

Furthermore, the reference numerals and/or reference letters may be repeated in different examples of the disclosure. Such repetition is for the purpose of simplicity and clarity and does not in itself indicate a relationship between the various embodiments and/or settings discussed. Furthermore, the disclosure provides examples of various specific processes and materials, but those may recognize the application of other processes and/or the use of other materials.

With an improvement of living standards, electrical apparatuses such as refrigerators and the like have become widely used in lives of people. In order to maintain a sealing performance of the above electrical apparatuses, an adsorption structure is usually disposed between a box body and a door body of the electrical apparatuses, or a negative pressure is maintained inside relative to outside of the electrical apparatuses to stably fix the door body onto the box body. Although a related performance of the electrical apparatus is improved in this way, a difficulty of opening the door body is also increased to a certain extent. Since a larger force is usually required to open the door body of the refrigerator, it is inconvenient to use. Therefore, in order to improve a convenience and safety of operation, an automatic door opening and closing device may be disposed between the door body and the box body. An implementation mechanism for door opening and closing can be driven by a driving mechanism to realize an auxiliary door opening and closing operation. However, the door opening and closing device in the related art has a relatively complex structure with a large size. When it is installed on an electrical apparatus, it requires a large amount of space, especially in a height direction. As a result, the electrical apparatus has high requirements for height conditions for on-site layout, which causes certain inconveniences for an on-site placement of electrical products. At the same time, a too high automatic door opening and closing device also affects aesthetics of products.

Embodiments of the disclosure are described below with reference to the accompanying drawings and embodiments.

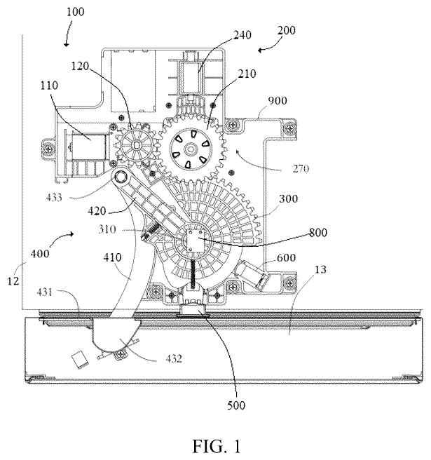

As shown in FIG. 1, a refrigerator according to one or more embodiments of the disclosure is provided with a door opening and closing device on a box body 12 for realizing automatic rotation of a door body 13 to realize automatic door opening and closing. Thus, a convenience and comfortability of a door opening-closing operation can be improved.

In one or more embodiments of the disclosure, the door opening and closing device may include: a driving mechanism 100, a clutch mechanism 200, a clutch-ejection-push assembly 240, a linkage gear 300 and a door rotation mechanism 400. The driving mechanism 100 sequentially drives the clutch mechanism 200, the linkage gear 300 and the door rotation mechanism 400 to realize an operation for rotating the door body, to implementing a door opening-closing operation. In some embodiments, the clutch-ejection-push assembly 240 may be configured as a portion of the clutch mechanism 200 to form a clutch functional mechanism, which can selectively cut off or communicate a transmission path of a transmission structure of the door opening and closing device, to implement a transmission control between the driving mechanism 100 and the implementation mechanism for door opening and closing, and thus a switching between an automatic door-opening-closing operation and a manual door-opening-closing operation can be implemented. It can ameliorate a problem of mutual interference between the manual door-opening-closing operation and the door opening and closing device, and enhance a convenience, smoothness and safety of use.

The door opening and closing device according to one or more embodiments of the disclosure is mainly applied on refrigerators to automatically open or close the door body 13.

The door opening and closing device can automatically open the door body 13 after receiving a door opening signal. In some embodiments, the door opening signal may be triggered by a user or by the electrical apparatus itself. The door opening and closing device, after receiving a door closing signal, can automatically close the door body 13. In some embodiments, the door closing signal may be triggered by a user or by the electrical apparatus itself.

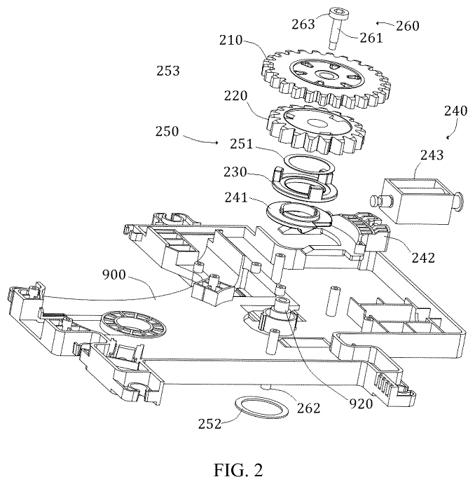

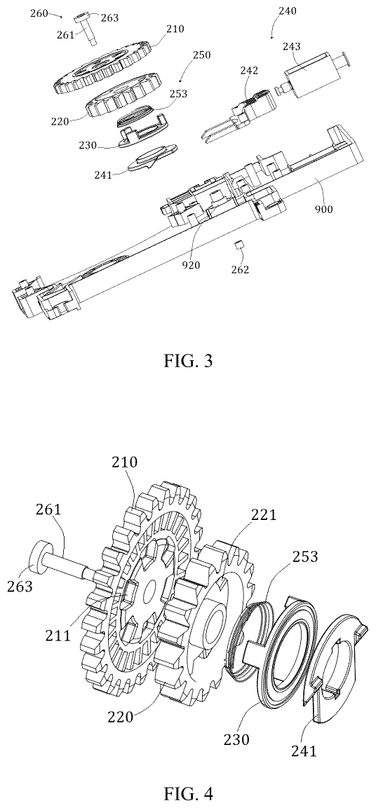

As shown in FIG. 1, FIG. 2, FIG. 3 and FIG. 4, in one or more embodiments of the disclosure, the clutch mechanism 200 may include a first transmission assembly 210 and a transmission structure which are separably connected. The transmission structure may include a second transmission assembly 220 for respectively connecting to the driving mechanism 100 and the linkage gear 300 of the door opening and closing device. An engagement and separation of the driving mechanism 100 and the linkage gear 300 are achieved by implementing, through the transmission connection assembly 230, an engagement and separation of the first transmission assembly 210 and the second transmission assembly 220, to control a connection state and separation state between the driving mechanism 100 and the door body 13. With an action of the clutch mechanism 20, a risk of interference between a manual operation of the door body and an automatic opening and closing operation of the door body through the driving mechanism can be reduced, to improve a convenience and safety of operation.

It is worth noting that the driving mechanism 100 includes a driver 110 and an output gear 120 connected thereto. The first transmission assembly 210 which is connected to the output gear 120 is directly driven by the output gear 120. The second transmission assembly 220 is normally connected to the linkage gear 300. Thus the transmission structure can be pushed to move through the clutch-ejection-push assembly 240 to be connected to or disconnected from the first transmission assembly 210. Thus, a simple clutch control can be realized.

In some embodiments, the first transmission assembly 210 and the output gear 120 are disposed side by side on the base 900, and thus a transmitting mechanism for a driving force can be flattened and the driving force can be transmitted laterally. This arrangement can greatly reduce an assembly height compared to vertically arranging the first transmission assembly 210 and the second transmission assembly 220 on the driver 110.

In some embodiments, the second transmission assembly 220 and the linkage gear 300 may be disposed side by side on the base 900, and thus the transmitting mechanism for the driving force is disposed in a flat manner and the driving force is transmitted laterally, to be capable of maintaining a low assembly height.

In some embodiments, the driver 110 may be fixed on the base 900 and located between the output gear 120 and the base 900. The second transmission assembly 220 is disposed between the first transmission assembly 210 and the base 900. An arrangement in a vertical direction relative to the base 900 takes into account requirements of a way of flattened layout and a reduced plane layout, to enable the entire door opening and closing device to be miniaturized.

In order to achieve a separable connection between the first transmission assembly 210 and the second transmission assembly 220, the transmission connection assembly 230 may be connected to the second transmission assembly 220. The transmission connection assembly 230 is pushed by the clutch-ejection-push assembly 240 to make the transmission connection assembly 230 to be separated from or connected to the first transmission assembly 210, to implement a connection and separation of the first transmission assembly 210 and the second transmission assembly 220.

The transmission connection assembly 230 itself, serving as a connecting component of the first transmission assembly 210 and the second transmission assembly 220, can move relative to the first transmission assembly 210. By pushing the transmission connection assembly 230 to move, a connection relationship between the transmission connection assembly 230 and the first transmission assembly 210 is established or released, to implement a connection and separation of the first transmission assembly 210 and the second transmission assembly 220. The clutch-ejection-push assembly 240 is used to implement a push-ejection operation on the transmission connection assembly 230.

As shown in FIG. 2, FIG. 3 and FIG. 10, in some embodiments, the clutch-ejection-push assembly 240 may include an ejection-push sleeve 241 and a push rod 242. The ejection-push sleeve 241 may be connected onto the transmission connection assembly 230. The push rod 242 is used to push the ejection-push sleeve 241, to be capable of pushing the transmission connection assembly 230, to enable the transmission connection assembly 230 to smoothly implement connection and disconnection operations with the first transmission assembly 210.

In one or more embodiments of the disclosure, the clutch mechanism 200 is connected between the driving mechanism 100 of the door opening and closing device and the implementation mechanism for door opening and closing that is connected to the door body 13 to establish or cut off the connection between the driving mechanism 100 and the implementation mechanism for door opening and closing, to solve a problem that the door opening and closing device of the refrigerator is easily interfered with a manual operation of the door body.

In some embodiments, a first transmission assembly 210 and a second transmission assembly 220 are respectively provided for respectively connecting the driving mechanism 100 and the linkage gear 300. A transmission connection assembly 230 connected to the second transmission assembly 220 is also provided and is separably connected to the first transmission assembly 210, to realize a separable connection between the first transmission assembly 210 and the second transmission assembly 220, and facilitate a clutch operation between the driving mechanism 100 and the linkage gear 300. The push sleeve 241 connected to the transmission connection assembly 230 is pushed and ejected by the push rod 242 to stably push the first transmission assembly 210 to be separated from or connected to the transmission connection assembly 230. Thus, the first transmission assembly 210 and the second transmission assembly 220 can be stably separated and connected in a working state, to improve a convenience, smoothness and safety of operating the door body 13 of the refrigerator.

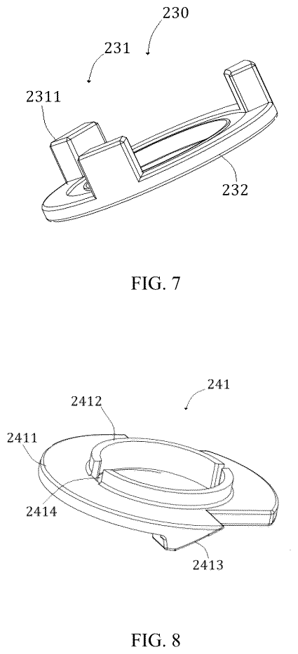

As shown in FIG. 7, in some embodiments, the transmission connection assembly 230 may be configured as a transmission connection member. The transmission connection member is provided with a connecting end 231 and an ejection-push end 232. The ejection-push end 232 is connected to the ejection-push sleeve 241. Thus, the transmission connection member is pushed by the ejection-push sleeve 241 to move, to enable the connecting end 231 to be separably connected on the first transmission assembly 210, to connect the first transmission assembly 210 and the second transmission assembly 220 as a whole or disconnect them.

In some embodiments, the transmission connection assembly 230 can be integrally provided with the second transmission assembly 220 or fixed on the second transmission assembly 220, and thus the second transmission assembly 220 and the transmission connection assembly 230 can move as a whole. The connection with and separation from second transmission assembly 220 can be achieved, and thus an assembly operation can be simplified.

In some embodiments, the connecting end 231 may be movably disposed on the second transmission assembly 220, to enable the connecting end 231 to move relative to the first transmission assembly 210 and the second transmission assembly 220 at the same time. Thus, the first transmission assembly 210 and the second transmission assembly 220 are stable in position and posture relative to each other, and thus a movement in a direction which is nor for transmission operations is not greatened. It is convenient for maintaining a stable connection with upstream and downstream components, to maintain a stability of working state.

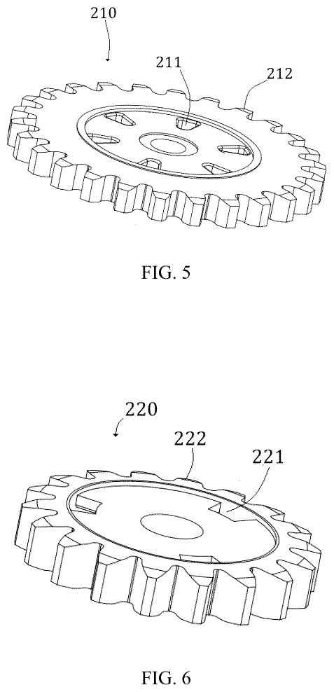

As shown in FIG. 4 and FIG. 5, in some embodiments, an engaging groove 211 may be formed on the first transmission assembly 210. The engaging groove 211 can be adapted to, and be snapped and embedded with the connecting end 231. Thus, a disengagement operation of the connecting end 231 from the engaging groove 211 can be smoothly implemented, to ensure a stability and reliability of a clutch operation.

As shown in FIG. 5, in some embodiments, the first transmission assembly 210 may be configured as a first transmission gear 212 to transmit a driving force through a way of gear meshing transmission. As a working mode of a gear rotating around its axis is taken into account, the engaging groove 211 may be disposed on an axial end face of the first transmission gear 212 to facilitate establishing and releasing a connection state between the connecting end 231 and the first transmission gear 212. An impact on working states of rotation and tooth meshing of the first transmission gear 212 can also be reduced.

It is worth noting that, in order to cooperate with a working posture of the first transmission gear 212, a way of movement of the second transmission assembly 220 may also be configured to be similar to a way that the first transmission gear 212 rotates around an axis, to achieve a synchronous rotation transmission.

As shown in FIG. 6, in some embodiments, the second transmission assembly 220 may be configured as a second transmission gear 222. The first transmission gear 212 and the second transmission gear 222 may be configured to be a coaxially rotating structure. The connecting end 231 may be disposed on the second transmission gear 222. The connecting end 231 can be connected to the first transmission gear 212 by pushing the ejection-push end 232, and thus the first transmission gear 212 and the second transmission gear 222 are connected and rotate synchronously, to establish a connected transmission path for the driving force.

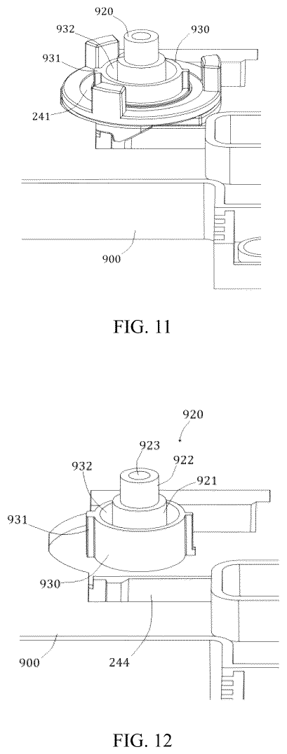

As shown in FIG. 2, FIG. 3, FIG. 11 and FIG. 12, in some embodiments, in order to achieve a rotation of the first transmission gear 212 and the second transmission gear 222, a rotating shaft structure may be disposed on the base 900 to guide an assembly and rotation of the first transmission gear 212 and the second transmission gear 222. In other embodiments, a common rotating shaft 920 may be disposed on the base 900. The first transmission gear 212 and the second transmission gear 222 may be sleeved on the common rotating shaft 920 along an axial direction to ensure a function stability of gear rotation.

In some embodiments, the common rotating shaft 920 may be configured as a variable-section shaft. A support column 921 and a rotating shaft column 922 are disposed in sequence from the base 900 upwardly. A diameter of the support column 921 is larger than a hole diameter of a shaft hole formed on the second transmission gear 222. A diameter of the rotating shaft column 922 can be adapted to the diameter of the shaft hole of the second transmission gear 222. Thus the second transmission gear 222 can be placed on the support column 921 and sleeved on the rotating shaft column 922, to make the second transmission gear 222 to be away from the base 900 by a certain height and to be rotated stably. The first transmission gear 212 can be stacked on the second transmission gear 222 and sleeved on the rotating shaft column 922 to be rotated.

In some embodiments, the connecting end 231 may be fixedly disposed on an axial end face of the second transmission gear 222. The second transmission gear 222 as a whole can be pushed toward or away from the first transmission gear 212 by pushing the ejection-push end 232, and thus the connecting end 231 is embedded with the engaging groove 211 or disengaged from the engaging groove 211. An overall operation is simple. A molding of structural members is relatively simple. An assembly operation is also simple and efficient.

As shown in FIG. 6, in some embodiments, an engaging hole 221 may be disposed on the second transmission gear 222, and the connecting end 231 can be movably embedded in the engaging hole 221, to push the ejection-push end 232. Thus, the connecting end 231 moves relative to the engaging hole 221 and approaches the first transmission gear 212, and in turn engages into the above-mentioned engaging hole 211 to establish a connection between the first transmission gear 212 and the second transmission gear 222. In a process of the connecting end 231 being disengaged from the engaging groove 211 and also moving relative to the engaging hole 221, a movement operation of the transmission connection member will have a lower impact on a position and posture of the first transmission gear 212 and the second transmission gear 222. It is convenient for maintaining a position and posture of rotation of the first transmission gear 212 and the second transmission gear 222, and helps to maintain a working state and operational reliability of the door opening and closing device.

In some embodiments, the engaging groove 211 may be configured as a through hole axially penetrating the first transmission gear 212, to be capable of preventing the connecting end 231 from directly pushing and ejecting a bottom of the engaging groove 211 to cause an unnecessary disturbance. Thus, a stability of rotation process of the first transmission gear 212 can be maintained.

In some embodiments, a working mode of rotation of the first transmission gear 212 and the second transmission gear 222 is considered, and in order to increase an efficiency of the connecting end 231 being engaged into the engaging groove 211, the connecting end 231 may be configured as connecting arms 2311. Accordingly, the number of the engaging grooves 211 may be the same as the number of the connecting arms 2311, or the number of the engaging grooves 211 may be more, to reduce a difficulty of the connecting arms 2311 being engaged into the engaging grooves 211.

It is worth noting that a rotation trajectory of the engaging groove 211 should be intersected with a movement trajectory of the connecting arm 2311, and thus the connecting arm 2311 can be embedded into the engaging groove 211.

In some embodiments, a distance from the connecting arm 2311 to an axis of rotating axle of the second transmission gear 222 should be consistent with a distance from the engaging groove 211 to an axis of rotating axle of the first transmission gear 212, and thus the engaging groove 211 and the connecting arm 2311 can be stably engaged and disengaged in an axial direction. Thus, an ejection-push force on the ejection-push end 231 is in a direction of the axis of rotating axle of the second transmission gear 222. The axis of rotating axle can be used as a reference during processing and assembly, to facilitate a disposing, assembly and ejection-push operation of the clutch-ejection-push assembly 240.

It is worth noting that a distance from the connecting arm 2311 to the axis of rotating axle of the second transmission gear 222 and the distance from the engaging groove 211 to the axis of rotating axle of the first transmission gear 212 may not be consistent. It is only required to ensure that a rotation trajectory of the engaging groove 211 should be intersected with the movement trajectory of the connecting arm 2311. When connecting arms 2311 and engaging grooves 211 are provided, an interval among the connecting arms 2311 and an interval among the engaging grooves 211 should be reasonably configured to avoid an inability of stable embedding.

In some embodiments, connecting arms 2311 may be arranged at an equal interval on a circular trajectory. Correspondingly, engaging grooves 211 may also be arranged at an equal interval on the circular trajectory, to be capable of forming a well-matched position and spacing arrangement pattern for an easy snapping-embedding.

It is worth mentioning that in order to increase an efficiency of matching and embedding between the connecting arm 2311 and the engaging groove 211, the number of the engaging grooves 211 may be appropriately increased. The number of the engaging grooves 211 may be set to be an integer multiple of the number of the connecting arms 2311, and thus in a condition that the engaging grooves 211 and the connecting arms are arranged at an equal interval, the efficiency of the adaptation and embedding between the connecting arms 2311 and the engaging grooves 211 can be greatly increased.

In some embodiments, the connecting arms 2311 may also be disposed on circular trajectories. Accordingly, a matched number of engaging grooves 211 should be provided on the first transmission gear 212 with reference to the circular trajectories to ensure a stable embedding.

In some embodiments, the ejection-push end 232 of the transmission connection member is directly connected to the ejection-push sleeve 241. It is considered that an ejection-push direction is perpendicular to rotation directions of the second transmission gear 222 and the first transmission gear 212, the transmission connection member can be configured to rotate around the rotating axle of the second transmission gear 222. The ejection-push end 232 is rotatably disposed on the ejection-push sleeve 241, and thus working states of a rotation movement and an axial movement of the transmission connection member can be both considered.

The ejection-push end 232 of the transmission connection assembly 230 may include an annular seat, and the annular seat may be rotatably connected to the ejection-push sleeve 241, to achieve working states of rotation and axial movement of the transmission connection assembly 230. On the other hand, the ejection-push sleeve 241 only needs to axially eject and push the annular seat without considering a rotation state of the annular seat. Thus, a structural setting and an installation configuration of the clutch-ejection-push assembly 240 can be greatly simplified.

It is worth mentioning that in order to reduce an interference of a movement operation of the transmission connection assembly 230 on the first transmission gear 212 and the second transmission gear 222, the annular seat may be disposed on a side of the second transmission gear 222 away from the first transmission gear 212. The connecting arm 2311 axially passes through the second transmission gear 222 and can be further moved and engaged into the engaging groove 211. Thus an operation of ejecting and pushing the annular seat will not be extended to be between two transmission gears, to be capable of maintaining a relative stability of the two transmission gears.

As shown in FIG. 8, in some embodiments, as the ejection-push sleeve 241 serves as a medium for ejecting and pushing, a shaft sleeve portion 2412 and a push-ejection portion 2411 may be disposed on the ejection-push sleeve 241, and the annular seat may be sleeved on the shaft sleeve portion 2412 to keep the annular seat in a rotatable state. Accordingly, the push-ejection portion 2411 is used to receive a push-ejection force from the push rod 242, and thus the ejection-push sleeve 241 as a whole moves along a direction of the axis of rotating axle of the first transmission gear 212 to implement an ejection-push operation for the transmission connection member.

In some embodiments, a moving direction of the ejection-push sleeve 241 may be the direction of the axis of rotating axle of the second transmission gear 222. For the convenience of description, the moving direction of the ejection-push sleeve 241 is defined as a first direction. In order to reduce an overall thickness of the door opening and closing device and reduce a difficulty of molding and assembly, the ejection-push sleeve 241 can be pushed with a variable direction. That is, a direction for pushing the push rod 242 is not the first direction, but is at a certain angle to the first direction, to reduce a requirement of space occupation in the first direction.

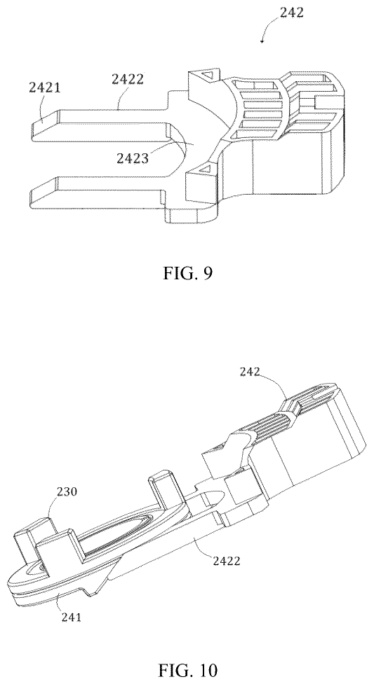

As shown in FIG. 8, FIG. 9 and FIG. 10, a first ejection-push surface 2413 may be disposed on the push-ejection portion 2411, and a second ejection-push surface 2421 may be disposed on the push rod 242. The first ejection-push surface 2413 and the second ejection-push surface 2421 can contact each other and slide relative to each other. The first ejection-push surface 2413 is disposed at an acute angle relative to the first direction. The ejection-push sleeve 241 can be ejected and pushed along the first direction by ejecting and pushing the first ejection-push surface 2413, to push the transmission connection member toward the first transmission gear 222.

In some embodiments, in order to optimize an efficiency of the ejection-push operations, an angle between the first ejection-push surface 2413 and the first direction may be set as ranging from 30 degrees to 60 degrees, for example, 30 degrees, 45 degrees or 60 degrees and so on.

In some embodiments, an angle between the ejection-push direction of the push rod 242 and the first direction may be controlled as 90 degrees, to minimize an arrangement space required for a cooperation relationship of the push rod 242 and the transmission connection member and reduce an overall volume of the door opening and closing device.

As shown in FIG. 9 and FIG. 10, in some embodiments, in order to balance a force on the ejection-push sleeve 241, the number of the first ejection-push surfaces 2413 may be set to be two, and the push rod 242 is also correspondingly provided with two push arms 2422 to correspondingly eject and push two first ejection-push surfaces 2413, to ensure a uniformity of a force on the ejection-push sleeve by applying force at two points. The two push arms 2422 may be connected to a same connection portion 2423 to achieve a synchronous action and ensure a consistent magnitude of applied force, to ensure an evenly applied force on the ejection-push sleeve 241. Correspondingly, the two push arms 2422 are respectively provided with a second ejection-push surface 2421.

In some embodiments, two first ejection-push surfaces 2413 may be disposed on two opposite sides of the ejection-push sleeve 241. The two push arms 2422 may be disposed in parallel. The second ejection-push surface 2421 may be disposed on an end of the push arm 2422 away from the connection portion 2423, and thus the ejection-push operations can be achieved by ejecting and pushing the connection portion 2423.

In some embodiments, the numbers of the first ejection-push surface 2413, the second ejection-push surface 2421, and the push arm 2422 may be set to more than two according to specifications of the ejection-push sleeve 241.

As shown in FIG. 2 and FIG. 3, in order to implement the ejection-push operations of the push rod 242, a linear driver 243 may be connected to the push rod 242 to eject and push the push rod 242 in a second direction or reset the push rod 242, and thus the ejection-push sleeve 241 may be pushed to move in the first direction by the linear-driver. When the linear driver 243 is reset, the push rod 242 releases the ejection-push sleeve 241.

In some embodiments, the linear driver 243 may be a linear driving assembly such as an electromagnetic push rod or a ball screw.

In some embodiments, a linear driver may be configured as a reduction motor, or a motor equipped with a reduction gearbox, to be capable of properly controlling an output torque and rotation speed.

As shown in FIG. 12, in some embodiments, in order to reduce an impact vibration between the push rod 242 and the base 900, and an impact vibration between the base 900 and the ejection-push sleeve 241, shock-absorbing pads 244 may be disposed between the base 900 and the push rod 242, and between the ejection-push sleeve 241 and the base 900.

In some embodiments, the ejection-push sleeve 241, since subjected to a friction action along a circumferential direction of the annular seat, has a certain tendency of circumferential rotation, and thus a cooperation of the ejection-push sleeve 241 with the clutch-ejection-push assembly 240 may be easily affected. An anti-rotation mechanism 930 may be disposed on the base 900, and snapped and embedded into the ejection-push sleeve 241 along the first direction to prevent a circumferential rotation of the ejection-push sleeve 241.

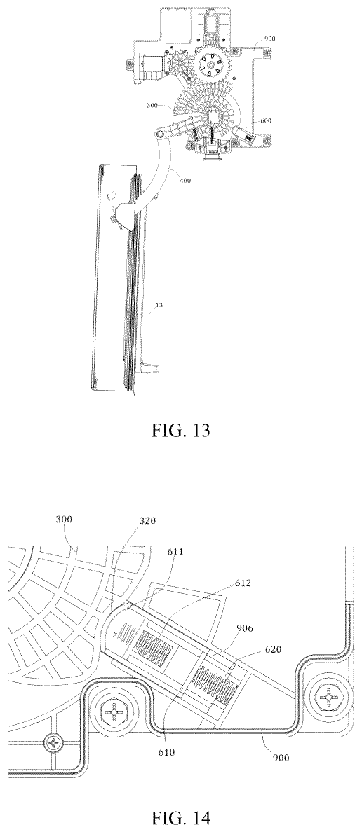

As shown in FIG. 8, FIG. 12 and FIG. 13, in some embodiments, the anti-rotation mechanism 930 may include an anti-rotation rib 931. The anti-rotation rib 931 can slide relative to the ejection-push sleeve 241 in the first direction, to prevent both the circumferential rotation and a sliding in the first direction of the ejection-push sleeve 241. Generally speaking, an anti-rotation slot 2414 may be formed in the ejection-push sleeve 241. The anti-rotation can match the anti-rotation rib 931. The anti-rotation slot 2414 and the anti-rotation rib 931 can relatively slide along the first direction.

In some embodiments, the number of combined structures formed by the anti-rotation ribs 931 and the anti-rotation slots 2414 may be several. Intervals among anti-rotation ribs 931 may be set to be unequal, and thus an assembly position of the ejection-push sleeve 241 and the anti-rotation rib 931 is unique. Thus, a stable and reliable alignment of the first push surface 2413 and the second push surface 2421 during assembly can be ensured, to avoid an assembly misalignment and achieve an effective effect of mechanical anti-misalignment.

In some embodiments, a raised cylindrical member may be disposed on the base 900. The anti-rotation rib 931 may be disposed on an outer wall of the cylindrical member. The ejection-push sleeve 241 may be sleeved on the outside of the cylindrical member to achieve positioning and guiding. In an embodiment, the cylindrical member may be disposed coaxially with the common rotating shaft 920.

As shown in FIG. 2, FIG. 3 and FIG. 4, in some embodiments, in order to achieve an immediate and efficient response when a connection between the connecting end 231 and the first transmission assembly 210 is released, that is, to achieve an immediate and efficient disconnection between the connecting end 231 and the first transmission assembly 210, a separation assembly 250 may be provided to apply an action force to the transmission connection assembly 230 for disengaging from the first transmission assembly 210. After the push rod 242 is reset and a sufficient moving space is left, the transmission connection assembly 230 is separated from the first transmission assembly 210 under an action of the separation assembly 250.

In some embodiments, the separation assembly 250 may be connected to the transmission connection assembly 230 and the second transmission assembly 220 respectively.

The connecting end 231 is caused, by pushing the ejection-push end 232 to move relative to the second transmission assembly 220, to be disconnected from the first transmission assembly 210.

In order to improve a response time, the separation assembly may be configured as an elastic reset member 253 to continuously apply an action force of disengaging the transmission connection assembly 230 from the first transmission assembly 210. During the push rod 242 pushes the ejection-push sleeve 241 and the transmission connection assembly 230 to be connected to the first transmission assembly 210 and maintain a connected state, the action force of the elastic reset member 253 still exists but is limited by a stronger force of mechanical movements of the push rod 242, the ejection-push sleeve 241 and the transmission connection assembly 210, and thus the action force for separating is offset. When a state in which the push rod 242 pushes the ejection-push sleeve 241 is changed, the ejection-push sleeve 241 is reset and moves backward, and the ejection-push sleeve 241 will gradually reduce the push-ejection force. The action force of the elastic reset member 253 will push and eject the connecting end 231 of the transmission connection assembly 230 to be disconnected from the first transmission assembly 210, to achieve a good response time.

In some embodiments, the elastic reset member 253 may be configured as a spring. The spring may be disposed between the ejection-push end 232 and the second transmission assembly 220 to continuously apply an elastic action force to disengage the transmission connection assembly 230 from the first transmission assembly 210.

In some embodiments, the separation assembly 250 may be connected to the second transmission assembly 220 and the base 900 respectively to guide the transmission connection assembly 230 to move relative to the base 900, and thus the connecting end 231 of the transmission connection assembly 230 can be disengaged from a connection relationship with the first transmission assembly 210.

In some embodiments, the separation assembly 250 may be configured as a first separation member 251 and a second separation member 252 which have a magnetic action force. A magnetic adsorption action force and a magnetic repulsion action force of the first separation member 251 and the second separation member 252 can be used to move the transmission connection assembly 230 relative to the base 900 to disconnect a connection state between the transmission connection assembly 230 and the first transmission assembly 210.

In some embodiments, the first separation member 251 and the second separation member 252 may be configured as magnetically absorbed metal members and magnets, to form a continuous separating action force.

As shown in FIG. 2, FIG. 3, FIG. 4 and FIG. 12, in some embodiments, the first transmission gear 212 and the second transmission gear 222 may be stopped on the common rotating shaft 920 by the stop assembly 260, and be restricted from an axial disengagement from each other, to ensure a stability and reliability of transmission structure.

In some embodiments, the stop assembly 260 be configured as a connecting member 261 and a stop member 263. An end of the connecting member 261 is connected to the base 900, or is connected to a structure, such as the common rotating shaft 920, on a surface of the base 900, The first transmission assembly 210 and the second transmission assembly 220 are disposed on the connecting member 261. Then the stop member 263 is fixed to another end of the connecting member to block the first transmission assembly 210 and the second transmission assembly 220 to prevent a disengagement of the first transmission assembly 210 or the second transmission assembly 220 from the connecting member 261, to ensure a stability of clutch transmission structure.

In some embodiments, the connecting member 261 and the stop member 263 may be integrated and configured into a bolt with head, with a bolt head serving as the stop member 263. In one embodiment, an independent stop member 263 may be provided and sleeved on a bolt rod, with a bolt head restricting a disengagement of the stop member 263.

In some embodiments, a fastening through hole 923 may be disposed at a top end of the common rotating shaft 920 along an axial direction of the common rotating shaft 920 for cooperating with a bolt with head to lock the first transmission assembly 210 and the second transmission assembly 220.

In some embodiments, a rod portion of the bolt with head may be configured as a smooth peripheral surface, and then an inner wall surface of the fastening through hole 923 may be configured as a smooth inner peripheral surface to achieve low friction matching between the rod portion and the inner wall surface, to avoid affecting transmission operations of the first transmission assembly 210 and the second transmission assembly 220. A lock member 262 may be disposed at another end of the fastening through hole to lock the bolt with head. The lock member 262 may be a latch or a nut.

In some embodiments, the connecting member 261 may be configured as a connecting shaft. An end of the connecting shaft is fixed on the base 900. The first transmission assembly 210, the second transmission assembly 220 and the ejection-push sleeve 241 are sleeved on the connecting shaft to restrict a disengagement along a radial direction of the connecting shaft. The stop member 263 may be configured as a baffle. The baffle is fixedly disposed to another end of the connecting shaft, to implement a limitation along an axial direction of the connecting shaft and stop the first transmission assembly 210, the second transmission assembly 220 and the ejection-push sleeve 241 from disengaging in the axial direction.

In some embodiments, the baffle may be integrally formed on the connecting shaft.

In some embodiments, the baffle may be detachably fixed to the connecting shaft, such as by being snapped and embedded in a narrow neck groove at an end of the connecting shaft through an engaging hole or an engaging groove that is formed on the baffle, or in a similar manner to a snapping-embedding manner.

In some embodiments, a baffle may also be fixed onto the connecting shaft via a lock member such as a latch that is connected to an end head portion of the connecting shaft.

When a clutch control is performed, the linear driver 243 is actuated to push the push rod 242 to move toward the ejection-push sleeve 241, and the second push surface 2421 that is formed at a head end of the push rod 242 ejects and pushes the first push surface 2413, and thus the ejection-push sleeve 241 moves along the first direction to push and eject the connecting end 231 to move toward the first transmission gear 212 until the connecting end 231 is embedded into the engaging groove 211, and thus the first transmission gear 212 and the second transmission gear 222 are connected as a whole. At this time, the linear driver 243 stays at the current position and supports the ejection-push sleeve 241 through the push rod 242 at the bottom 900, to support the transmission connection member, and thus the first transmission assembly 210 and the second transmission assembly 220 are maintained in a transmission connection state. When a disconnection is required, the linear driver 243 is reset, and the connecting end 231 of the transmission connection member gradually disengages from the engaging groove 211 under an action of the separation assembly 250 until the first transmission gear 212 and the second transmission gear 222 are disconnected. Thus, the transmission path for the driving force is disconnected.

As shown in FIG. 1 and FIG. 13, in some embodiments, when the door body 13 is rotated to a position with a preset opening, the linkage gear 300 will no longer drive the door rotation mechanism 400 to act, and a driving force will be stopped from applying to the linkage gear 300 to keep the door body at a current position, that is, a driving relationship between the door body 13 and the upstream driving device is broken off, to avoid an interference with manual operation of the door body 13, and thus to facilitate a manual operation of the door body 13. However, a center of gravity of the door body is caused to be shifted due to items stored on the door body 13 of an electrical apparatus such as a refrigerator, or a tilted placement of the refrigerator, which can result in an autonomous deflection of the door body 13, and thus the door body 13 cannot maintain an opening. Thus, it is inconvenient to use and even causes a safety risk of collision to an operator.

As shown in FIG. 13 and FIG. 14, in order to solve a problem that the door body 13 cannot maintain an opening when the door opening and closing device is shut down, a limit structure 320 may be formed on the linkage gear 300, and a suspension mechanism 600 may be disposed on the base 900. When the linkage gear 300 is rotated to a position where the limit structure 320 is opposite to the suspension mechanism 600, the suspension mechanism 600 moves and then ejects and abuts against the limit structure 320, to lock the linkage gear 300 on the base 900, to prevent the door rotation mechanism 400 from rotating the door body, to achieve a suspension of the door body 13 and maintain a position with preset opening.

That is to say, the limit structure 320 is rotated with the linkage gear 300. The suspension mechanism 600 can move relative to the base 900, and can change a movement state of the suspension mechanism 600 in response to a rotation of the linkage gear 300. Thus, when the limit structure 320 is rotated to a position where the limit structure 320 matches and is opposite to the suspension device 600, the suspension device 600 can eject and abut against, and clamp the limit structure 320, to lock the linkage gear 300 and limit the rotation of the linkage gear 300, and thus the door rotation mechanism can be braked to prevent the door body 13 from deflecting, to keep the door body 13 to be suspended at a preset position.

It is worth mentioning that a state of ejecting and abutting against for locking of the suspension mechanism 600 and the limit structure 320 is a reversible state. When an external driving force applied to the linkage gear 300 is greater than a braking force between the suspension mechanism 600 and the limit structure 320, the linkage gear is enabled to break through an action of ejecting and abutting against for limiting, and thus the linkage gear 300 goes on to be rotated and to be released from a braking state, to be capable of driving the door rotation mechanism 400 to rotate the door body 13 to be closed, or further expanding an opening of the door body 13.

As shown in FIG. 14 and FIG. 16, the suspension mechanism 600 may include a suspension member 610 and a push-ejection member 620. The suspension member 610 is movably disposed on the base 900, and continuously ejects and abuts against the linkage gear 300, and can match, eject and abut against, and clamp the limit structure 320. When the linkage gear 300 makes the limit structure 320 in a state opposite to the suspension member 610, the suspension member 610 can move toward the linkage gear 300 and eject and abut against the limit structure 320, to lock the linkage gear 300 on the base 900 to achieve a braking of the linkage gear 300. The push-ejection member 620, as a driving element of the suspension member 610, continuously provides a pushing and ejecting force to the suspension member, to push and eject the suspension member 610 toward the linkage gear 300, to be capable of pushing and ejecting the suspension member 610 and the limit structure 320 to eject and abut against the linkage gear 300 for braking.

It should be noted that, the suspension member 610, under an action of continuous pushing and ejecting force, always maintains a state of abutting against the linkage gear 300. During a rotation of the linkage gear 300, the suspension member 610 slides on the linkage gear 300. Only in a condition that the linkage gear 300 is rotated to a state in which the limit structure 320 is opposite to the suspension mechanism 600, the suspension member 610 moves and ejects and abuts into the limit structure 320 under the action of the pushing and ejecting force, to brake the linkage gear 300. The continuous pushing and ejecting force enables the suspension member 610 to track a position of rotating peripheral surface of the linkage gear 300 and respond to a rotating state of the limit structure 320 in a timely manner. That is, after the limit structure 320 and the suspension mechanism 600 are in corresponding positions, the suspension member 610 immediately ejects and abuts against and clamps the limit structure 320. An ejecting-abutting portion 611 may be disposed on the suspension member 610 for contacting, ejecting and abutting against the limit structure 320, and may be ejected and abutted into an interior of the limit structure 320 to implement contacting, ejecting and abutting for braking.

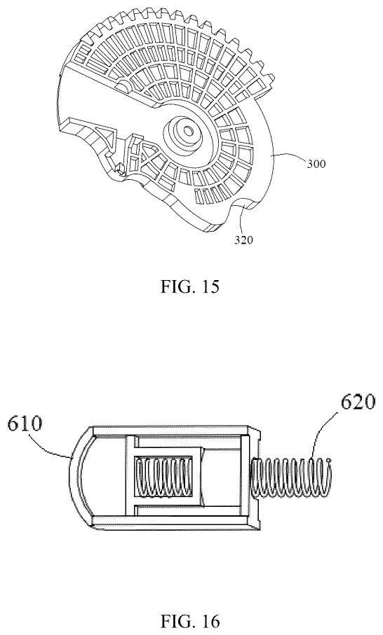

As shown in FIG. 15, in some embodiments, the limit structure 320 may be configured as a groove located on a peripheral surface of the linkage gear 300. Accordingly, the ejecting-abutting portion 611 of the suspension member 610 may be configured as a shape that matches a groove shape of the groove and ensures that the ejecting-abutting portion 611 can be snapped and embedded into the groove and disengaged from the groove, to facilitate a smooth clamping for braking of the ejecting-abutting portion 611 and a releasing from braking of the ejecting-abutting portion 611.

It is worth noting that a notch of the groove may be provided with a jointing surface for smoothly jointing to a peripheral surface of the linkage gear 300, to facilitate the ejecting-abutting portion 611 to slide smoothly into the groove relative to the peripheral surface of the linkage gear 300 and be smoothly disengaged from the groove, and thus the braking and a releasing from braking can be both achieved smoothly and stably.

In some embodiments, a groove shape of the groove may be configured to be C-shaped or V-shaped, and accordingly, the ejecting-abutting portion 611 may also be configured to be an embeddable arc-shaped or spire-shaped structure.

In order to facilitate the ejecting-abutting portion 611 to be smoothly disengaged from the groove, a certain gap may be left between the ejecting-abutting portion 611 and the groove, that is, when the ejecting-abutting portion 611 is snapped and embedded in the groove, a portion of the ejecting-abutting portion 611 is ejected and abutted against an inner wall of the groove, and a gap is formed between another portion of the ejecting-abutting portion 611 and a groove wall of the groove. Therefore, under a premise of ensuring a clamping of the ejecting-abutting portion 611 and the groove, the ejecting-abutting portion 611, when subjected to a force slightly greater than the pushing and ejecting force, can also be smoothly disengaged from the groove.

As shown in FIG. 14 and FIG. 18, in some embodiments, it is considered that a stability of the pushing and ejecting force and a stability of acting effect of the pushing and ejecting force have a positive effect on a braking performance of the ejecting-abutting portion 611. A push-ejection limit slot 612 may be formed on the suspension member 610, and the push-ejection member 620 may be disposed in the push-ejection limit slot 612, to maintain a relatively stable connection state between the push-ejection member 620 and the suspension member 610. Thus an amplitude of relative swing between the push-ejection member 620 and the suspension member 610 can be reduced to a certain extent, to maintain stabilities of a direction of subjected force, a movement direction of the ejecting-abutting portion 611, and a contact area between the ejecting-abutting portion 611 and the limit structure 320, to ensure a braking effect.

In some embodiments, the push-ejection member 620 may also be directly connected to the ejecting-abutting portion 611 to concentrate an action point of the pushing and ejecting force on the ejecting-abutting portion 611, to reduce a risk of directional deviation of the pushing and ejecting force and an unstable ejecting-abutting effect due to changes in postures of the suspension member 610 itself.

It is worth noting that specifications of sizes of the push-ejection limit slot 612 and the push-ejection member 620 may be designed to match one another. The width of the push-ejection limit slot 612 may be slightly larger than a width of the push-ejection member 620, to reduce a space for relative swing to maintain a stability of direction of the pushing and ejecting force.

In some embodiments, a push-ejection limit slot 612 may be configured as a blind hole along a direction of the pushing and ejecting force and capable of accommodating the push-ejection member 620. A bottom of the push-ejection limit slot 612 is disposed on the ejecting-abutting portion 611 to form a limit along a circumferential direction for the push-ejection member 620, to limit a swing amplitude in the circumferential direction, reduce a risk of the suspension member 610 bouncing up under force, and ensure a stability of position and posture of ejection and push.

In some embodiments, an ejecting-abutting portion 611 is disposed at an end of the suspension member 610 for contacting, ejecting and abutting against the limit structure 320. A connecting portion may also be disposed at another end of the suspension member 610 for connecting the push-ejection member 620. Thus, a molding and processing of the suspension member can be facilitated and a flow of processing can be simplified.

In some embodiments, the push-ejection member 610 may be configured as an elastic member, and thus a continuous and successive pushing and ejecting force is applied through an elastic deformation of the elastic member, to ensure that the suspension member 610 responds to the position changes of the rotating peripheral surface of the linkage gear 300 with a simple structure and high time efficiency, and can be quickly ejected and abutted into the limit structure 320 when the limit structure 320 is in place. At the same time, a stability of the elastic deformation of the elastic member enables the pushing and ejecting force applied to the suspension member 610 to maintain a stable state. On the one hand, a stability of a suspended state can be maintained, and on the other hand, the linkage gear 300 can also be enabled to be rotated to release a braking state under an action of a relatively stable and controllable driving force, to achieve a stability, a reliability of a suspension function and a performance for smooth implementation of the suspension function of the door opening and closing device.

It is considered that a deformation of the elastic member can be divided into a compressed deformation and a stretched deformation. The elastic member should be assembled in a way that can maintain a relatively stable and linear deformation state of the elastic member.

When the elastic member in a compressed state provides an elastic pushing and ejecting force, the suspension member 610 may be disposed between the elastic member and a peripheral surface of the linkage gear 300. The elastic member is compressed and disposed between the base 900 and the suspension member 610, and a reset direction of deformation of the elastic member is kept consistent with a direction of the pushing and ejecting force, to convert an elastic pushing force of the elastic member into a stable elastic pushing and ejecting force to output.

When the elastic member in a stretched state provides an elastic pushing and ejecting force, the elastic member can be stretched and disposed between the base 900 and the suspension member 610, and the reset direction of deformation of the elastic member is kept consistent with a direction of the pushing and ejecting force, to convert an elastic pulling force of the elastic member into a stable elastic pushing and ejecting force to output.

In some embodiments, the elastic member may be a spring and may be configured as a compression spring or a tension spring, to provide a stable pushing and ejecting force through a compressed deformation or a stretched deformation. The compression spring may be compressed between the suspension member 610 and the base 900, or the tension spring may be stretched and connected between the suspension member 610 and the base 900.

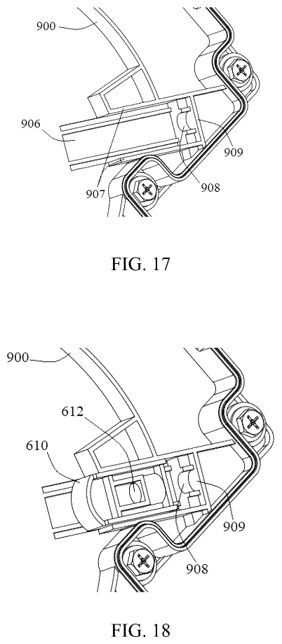

As shown in FIG. 17 and FIG. 18, a first end of the compression spring can be ejected and abutted against the ejecting-abutting portion 611. A boss portion 909 with a height substantially equal to that of spring is disposed on the base 900. A second end of the compression spring can be ejected and abutted against the boss portion 909 to keep the compression spring in a straight posture in an axial direction thereof, to form a stable and reliable pushing and ejecting force.

The first end of the tension spring may be fixed on a body of the push-ejection member 610, or directly fixed on the ejecting-abutting portion 611, and the second end of the tension spring may be fixed on the boss portion 909 that is disposed on the base 900. The tension spring should be kept flush with a plate surface of the base 900 and in a straight posture as much as possible to form a stable and reliable push-ejection force.

In some embodiments, a support groove 908 may be further disposed below the boss portion 909 to limit and support the above springs, to ensure a stability of ejecting and abutting position of the springs and avoid shaking.

In some embodiments, the elastic member may also be an elastic member such as a torsion spring, a leaf spring, etc., as long as a direction of elastic force of the elastic member is roughly consistent with a moving direction of the suspension member 610, which will not be repeated here.

In some embodiments, in order to maintain a stability of moving direction of the suspension member 610 and limit an excessive swing and vibration of the suspension member, a suspension limit slide groove 906 may be disposed on the base 900, and the suspension member may be disposed in the suspension limit slide groove 906. The stability of the moving direction of the suspension member 610 is maintained by a guiding and restraining effect of side walls of the suspension limit slide groove 906, to ensure a reliability of braking performance.

As shown in FIG. 17, in some embodiments, the suspension limit slide groove 906 may be configured as a gap between two opposite limit bosses 907. The limit bosses 907 may have a certain length in the moving direction of the suspension member 610, as long as the length can ensure that a limit for the suspension member 610 within a sliding stroke can be achieved. An upper limit structure may also be connected to a top of the two limit bosses 907 to limit the suspension member 610 from the base to a certain extent. A corresponding upper limit structure may also be disposed and covered on the base 900. The upper limit structure is opposite to the suspension limit slide groove 906 to achieve a purpose of upper limit. Thus, the suspension member 610 can always move in a stable direction to ensure a reliability of braking performance.

In some embodiments, in order to maintain the stability of the moving direction of the suspension member 610 and limit an unstable swinging of the suspension member 610, the suspension member 610 may be configured as rod-shaped, and the ejecting-abutting portion 611 is disposed at an end of the suspension member 610 which is close to the linkage gear 300, that is, the suspension member 610 may be configured as a structural member with long strip shape having a certain length to cooperate with the suspension limit slide groove 906 to implement a stable sliding. A length characteristic of the long strip structural member and a radial limit effect of the suspension limit groove 906 on the long strip structural member can be utilized to reduce a swing amplitude to a certain extent. The longer a length in a direction of the pushing and ejecting force of the suspension limit slide groove 906 and a length of the rod-shaped suspension member 610 are, the better a performance of limiting the swing amplitude is, and the more stable the moving direction of the suspension member 610 is.

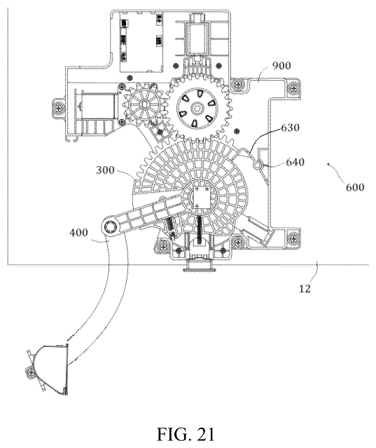

As shown in FIG. 21, in some embodiments, the suspension mechanism 600 may also be configured as an engaging-braking structure in which a suspension-connection member 630 and a suspension-limit groove 640 cooperate with each other. The suspension-connection member 630 is connected on the linkage gear 300, and the suspension-limit groove 640 is disposed on the base 900. The linkage gear 300 rotates to drive the suspension-connection member 630 to be engaged with the suspension-limit groove 640, to brake the door rotation mechanism 400 to rotate the door body 13.

It is easily understood that when the linkage gear 300 is rotated counterclockwise, the linkage gear 300 is rotated along a direction for suspension engagement. When the linkage gear 300 is rotated, the suspension-connection member 630 can be smoothly snapped and embedded in the suspension-limit groove 640, to connect the linkage gear 300 and the base 900 as one, and thus a braking of the linkage gear 300 and a braking of the door rotation mechanism 400 connected to the linkage gear 300 can be achieved.

It is worth noting that a position of the suspension-limit groove 640 may be configured to match that of the suspension-connection member 630, to cause that the suspension-connection member 630 can be inserted counterclockwise into the suspension-limit groove 640, and be relatively difficultly removed counterclockwise from the suspension-limit groove 640, but be easily removed clockwise from the suspension-limit groove 640. Thus, a stable and reliable engagement and removal can be achieved.

As shown in FIG. 1, in some embodiments, the door rotation mechanism 400 may include a front connecting rod 410 and a rear connecting rod 420 which are in a hinged connection at ends. Another end of the front connecting rod 410 is rotatably connected to the door body 13 at a first connection point. The front connecting rod 410 is disposed between a bottom surface of the linkage gear 300 and the base 900. The rear connecting rod 420 is deflectably disposed in an installation groove which is formed on a top surface of the linkage gear 300. Another end of the rear connecting rod may be rotated coaxially with the rotation center 310 of the linkage gear 300, and the rear connecting rod 420 and the linkage gear 300 are connected to the base 900 at the rotation center 310 of the linkage gear 300, that is, the rear connecting rod 420 can be rotated with the linkage gear 300, and thus the front connecting rod 410 is pushed and pulled under pushes of a first abutting-holding surface and a second abutting-holding surface oppositely formed on groove walls of the installation groove to rotate the door body 13, to implement operations of door opening and closing.

It is worth mentioning that the front connecting rod 410 and the rear connecting rod 420 are respectively disposed on two sides of the linkage gear 300, that is, reserved spaces at two sides along a thickness direction of the linkage gear 300 which is rotatably supported on the base 900 can be utilized for disposing the front connecting rod 410 and the rear connecting rod 420 respectively without occupying a space above the linkage gear 300, to reduce a space requirement of the door rotation mechanism 400 in a thickness direction to a certain extent. The rear connecting rod 420 is sunken and disposed in the installation groove, to make an overall assembly height of the door rotation mechanism 400 and the linkage gear 300 not be excessively higher than a height of the linkage gear 300, and even be the same. Overall, a thickness of the door opening and closing device can be reduced by disposing the front connecting rod 410 and the rear connecting rod 420 at the two sides respectively and using the installation groove.

In some embodiments, the front connecting rod 410 and the rear connecting rod 420 can also be disposed in a space below the linkage gear 300 and is located above the base 900. The installation groove is also disposed on a bottom surface of the linkage gear 300, to reduce an overall thickness of the door opening and closing device as a whole.

As shown in FIG. 1, in some embodiments, the door rotation mechanism 400, the driving mechanism 100 and the clutch-ejection-push assembly 240 may be disposed on a same side of a line connecting the clutch mechanism 200 and the linkage gear 300, to improve a compactness of overall structure to a certain extent. Thus, a width of overall lateral layout can be relatively reduced, to implement a miniaturization of the door opening and closing device. Thus, the door opening and closing device 11 have a good installation compatibility, to facilitate an installation on a refrigerator and reduce an interference with the refrigerator and surrounding environment of the refrigerator.

In some embodiments, the door body 13 and the box body 12 are rotatably connected at a first connection point. The front connecting rod 410 and the door body 13 are connected at a second connection point. The rear connecting rod 420 and the front connecting rod 410 are rotatably connected at a third connection point. The linkage gear 300 has a rotation center. The second connection point and the third connection point 433 are respectively located on two sides of a line connecting the first connection point and the rotation center, and thus points of force application of two connecting rods are respectively located on two sides of the above-mentioned line. When deformation due to force occurs on the two connecting rods, deformation directions or trends of the two connecting rods will be in two opposite directions of a rod body, to avoid a deviation to a same side and maintain a balance at a stable interface. Thus, a stable structure for force application can be obtained, and an excessive deformation can be prevented from affecting an overall shape stability of the door opening and closing device.

In some embodiments, an angle between a first connecting line which connects the output gear 120 with the first transmission gear 212 and the second connecting line which connects the second transmission gear 222 with the linkage gear 300 may be controlled to range from 90 degrees to 120 degrees, and thus the driving mechanism 100, the door rotation mechanism 400 and the clutch-ejection-push assembly 240 disposed on a same side all have sufficient installation space.

The door rotation mechanism 400 may be disposed in an area enclosed by the first connecting line, the second connecting line and the door body.

In some embodiments, since the entire front connecting rod 410 and a portion of the rear connecting rod 420 rotate in the air and may not directly contact or be connected to other structures, a corresponding base structure may not be provided in an area swept by the entire front connecting rod 410, and thus the front connecting rod 410 can be disposed outside an area where the base 900 is located. On the one hand, a material consumption of the base 900 is reduced, and on the other hand, a fixing structure for the base 900 can be kept away from functional portions, such as a wiring area in an edge area of the refrigerator 10 and the like, to a certain extent, to achieve a good installation compatibility and adaptability to an environment.

In some embodiments, the driver 110 may be fixed on the base 900, and the output gear 120 may be disposed above the driver 110 with a certain installation height, and thus the first transmission gear 212 and the output gear 120 may be disposed side by side at a same height. Accordingly, the second transmission gear 222 and the linkage gear 300 are disposed side by side at a same height. The second transmission gear 222 is located below the first transmission gear 212, to make full use of a thickness space and the width space as a whole for an arrangement and coordination, and thus an overall thickness and width are at a relatively low level, to be convenient for a miniaturization of the door opening and closing device.

As shown in FIG. 1, in some embodiments, the door opening and closing device may also be provided with a door ejection mechanism 500 which is connected to the linkage gear 300. The door ejection mechanism 500 ejects and pushes the door body 13 during the rotation of the linkage gear 300, to break through an adsorption force between the door body 13 and the box body 12. Thus, the door body 13 is ejected to open, and a door rotation difficulty of the door rotation mechanism 400 is reduced. In an embodiment, the suspension mechanism 600, the door ejection mechanism 500 and the door rotation mechanism 400 are located on a circumferential side of the linkage gear 300, and the suspension mechanism 600 and the door rotation mechanism 400 are located on two sides of the door ejection mechanism 500, to be reasonably distributed and reduce a space occupation and a risk of mutual interference.

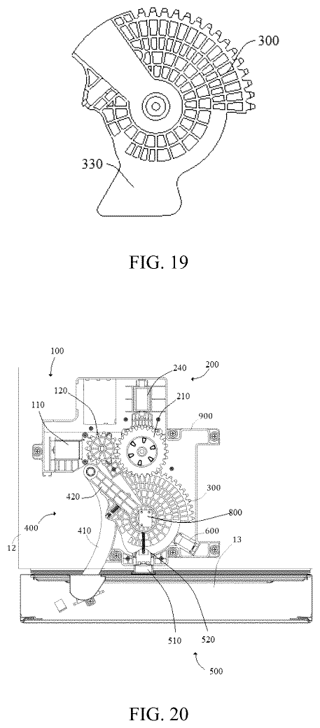

As shown in FIG. 19, in some embodiments, the door ejection mechanism 500 may be a door ejection portion 330 disposed on the linkage gear 300. In a condition that the driving mechanism 100 drives the linkage gear 300 to rotate via the clutch mechanism 200, the door ejection portion 330 can eject the door body 13 open.

As shown in FIG. 20, in some embodiments, the door ejection mechanism 500 may also be configured to include a door ejection member 510 that is movably disposed on the base 900 and an abutting-holding portion 520 that is disposed on a peripheral surface of the linkage gear 300. In a condition that the driving mechanism 100 drives the clutch mechanism 200 to drive the linkage gear 300 to rotate, the abutting-holding portion 520 formed on the linkage gear 300 can rotate with the linkage gear 300 to push the door ejection member 510 to move relative to the base 900, to make the door ejection member 510 to eject the door body 13 open. Thus the door ejection member 510 is guided by a curved surface that fluctuates radially of the abutting-holding portion to gradually eject and push the door body 13 until the door body 13 is opened. It is worth noting that an elastic reset member such as a spring and a leaf spring may be disposed on the base 900 or on an upper cover that is connected to the base 900 to make the door member 510 to be elastically ejected and abutted against the abutting-holding portion 520 of the linkage gear 300, to achieve a stable door ejection operation and a reset operation.

The door body 13 is rotated by a cooperation of the door rotation mechanism 400 and the driving mechanism 100 to realize an automatic door opening and closing operation. In an embodiment, the door rotation mechanism 400 is driven, through a forward rotation and reverse rotation of the linkage gear 300, to push and pull the door body 13 to realize a door opening and closing operation. The limit structure 320 is disposed on the linkage gear 300 as a functional structure for braking the linkage gear. A position of a rotating peripheral surface of the linkage gear is tracked by the suspension mechanism 600 slidably disposed on the base 900. When the linkage gear 300 rotates to a state in which the limit structure 320 is opposite to the suspension mechanism 600, the braking of the linkage gear is realized through the suspension mechanism 600 ejecting and abutting against the limit structure 320, to brake the door rotation mechanism 400 that is connected to the linkage gear 300. Thus, a suspension of the door body 13 can be realized. A stability of the opening of the door body 13 can be ensured. It is also convenient to use, while a door-opening difficulty can be reduced. A risk of collision can be reduced.

As shown in FIG. 20, in some embodiments, in order to better grasp the rotation of the linkage gear 300, an angle acquisition unit 800 may be provided to perform a real-time monitoring on a rotation angle of the linkage gear 300 as a control parameter.

Various angle sensors for measuring deflection angles may be used as the angle acquisition unit 800. A relative rotation angle of the linkage gear 300 relative to the base 900 or relative to an upper cover of the base 900 may be measured. The angle acquisition unit 800 can usually be configured as a combined detection assembly of a permanent magnet marker and a PCB induction circuit, one of which is disposed on an upper cover that cooperates with the base 900, and another of which is disposed on the linkage gear 300.

In addition, the various embodiments can be combined with one another, but the combined embodiments must be based on that they can be implemented. When the combined embodiments are contradictory or cannot be realized, it should be considered that such combined embodiments do not exist, and are not within the protection scope sought for by the disclosure.

Although embodiments of the disclosure have been shown and described, it will be appreciated that various changes, modifications, substitutions, and alterations may be made to the embodiments without departing from the principles and spirit of the disclosure, the scope of which is defined by the claims and equivalents thereof.

1. A refrigerator, comprising: a box body, a door body rotatably disposed on the box body, and a door opening and closing device connected on the box body and the door body;
the door opening and closing device comprises:
a base;
a driving mechanism comprising a driver fixedly disposed on the base and an output gear connected to the driver;
a clutch mechanism comprising a first transmission assembly and a transmission structure which are separably connected, wherein the first transmission assembly is connected to the output gear, the first transmission assembly and the output gear being disposed side by side on the base-a
a clutch-ejection-push assembly pushing the transmission structure to be connected to or separated from the first transmission assembly;
a linkage gear rotatably disposed on the base and connected to the transmission structure-the linkage gear and the transmission structure being disposed side by side; and
a door rotation mechanism, connected to the linkage gear and the door body, and driven by the linkage gear to drive the door body to rotate, and
wherein the door rotation mechanism comprises a front connecting rod and a rear connecting rod which are hingedly connected at tends, the front connecting rod being connected to the door body, the front connecting rod being disposed between a bottom surface of the linkage gear and the base, the rear connecting rod being deflectably disposed in an installation groove that is formed on a top surface of the linkage gear.

2. (canceled)

3. The refrigerator according to claim 1, wherein the door rotation mechanism comprises: a front connecting rod and a rear connecting rod which are in a hinged connection at ends, the front connecting rod being connected to the door body, the rear connecting rod being deflectably disposed in an installation groove that is formed on a top surface of the linkage gear, the front connecting rod and the rear connecting rod being disposed between a bottom surface of the linkage gear and the base.

4. The refrigerator according to claim 1, wherein the door rotation mechanism, the driving mechanism and the clutch-ejection-push assembly are located on a same side of a line connecting the clutch mechanism and the linkage gear.

5. The refrigerator according to claim 4, wherein the door body and the box body are rotatably connected at a first connection point, and wherein the front connecting rod and the door body are connected at a second connection point, and wherein the rear connecting rod and the front connecting rod are rotatably connected at a third connection point, the linkage gear having a rotation center, the second connection point and the third connection point being respectively located on two sides of a line connecting the first connection point and the rotation center.

6. The refrigerator according to claim 1, wherein the door opening and closing device further comprises a door ejection mechanism, the door ejection mechanism being a door ejection member movably disposed on the base, wherein in a condition that the driving mechanism drives the clutch mechanism to drive the linkage gear to rotate, an abutting-holding portion formed on the linkage gear is able to rotate with the linkage gear and push the door ejection member to move relative to the base, to make the door ejection member to eject the door body open.

7. The refrigerator according to claim 1, wherein the door opening and closing device further comprise a door ejection mechanism, wherein the door ejection mechanism comprises door ejection portion disposed on the linkage gear, wherein in a condition that the driving mechanism drives the linkage gear to rotate via the clutch mechanism, the door ejection portion is able to eject the door body open.

8. The refrigerator according to claim 1, wherein the transmission structure comprises a second transmission assembly and a transmission connection assembly connected to the second transmission assembly, wherein the transmission connection assembly is pushed by the clutch-ejection-push assembly to be connected to or separated from the first transmission assembly.

9. The refrigerator according to claim 8, wherein the first transmission assembly is a first transmission gear, the second transmission assembly being a second transmission gear, wherein the first transmission gear and the second transmission gear are coaxially rotatably disposed on the base, the first transmission gear being meshed with the output gear, the second transmission gear being meshed with the linkage gear.

10. The refrigerator according to claim 8, wherein the driver is fixedly disposed on the base and located between the output gear and the base, the first transmission gear and the output gear being disposed side by side, a second transmission gear and the linkage gear being disposed side by side, the second transmission gear being located below the first transmission gear.

11. The refrigerator according to claim 10, wherein an angle between a first connecting line which connects the output gear with the first transmission gear and a second connecting line which connects the second transmission gear with the linkage gear ranges from 90 degrees to 120 degrees.

12. The refrigerator according to claim 11, wherein the door rotation mechanism is disposed in an area enclosed by the first connecting line, the second connecting line and the door body.

13. The refrigerator according to claim 8, wherein the clutch mechanism further comprises a separation assembly that is respectively connected to the transmission connection assembly and the second transmission assembly to provide an action force for driving the transmission connection assembly to be separated from the first transmission assembly.

14. The refrigerator according to claim 13, wherein the separation assembly comprises an elastic reset member, two ends of which are respectively connected to the transmission connection assembly and the second transmission assembly to provide an elastic action force for driving the connecting end to be separated from the first transmission assembly.

15. The refrigerator according to claim 9, wherein the transmission connection assembly comprises a transmission connection member, wherein the transmission connection member is provided with a connecting end and an ejection-push end, the ejection-push end being movably embedded in an engaging hole that is formed on the second transmission gear, the ejection-push end being ejected and pushed by the clutch-ejection-push assembly to push the connecting end to be connected to or separated from an engaging groove that is formed on the first transmission gear.

16. The refrigerator according to claim 9, wherein the door opening and closing device further comprises a separation assembly which is connected to the transmission structure and the base to provide an action force for driving the transmission structure to be separated from the first transmission assembly.

17. The refrigerator according to claim 16, wherein the separation assembly comprises a first separation member and a second separation member which maintain magnetic action forces to each other, the first separation member being connected on the transmission structure and the second separation member being connected on the base, to provide a magnetic action force for driving the connecting end to be separated from the first transmission assembly.

18. The refrigerator according to claim 1, wherein the clutch mechanism further comprises a stop assembly, wherein the stop assembly comprises a connecting member and a stop member, an end of the connecting member being fixed on the base, the first transmission assembly and the transmission structure) being disposed on the connecting member, the stop member being fixed on another end of the connecting member to block the first transmission assembly and the transmission structure.

19. The refrigerator according to claim 1, wherein the door opening and closing device further comprises a suspension mechanism, the suspension mechanism being movably disposed on the base, a limit structure being formed on the linkage gear, wherein in a condition that the linkage gear rotates to a state in which the limit structure is opposite to the suspension mechanism, the suspension mechanism moves to eject and abut against the limit structure to prevent the door rotation mechanism from rotating the door body.

20. The refrigerator according to claim 1, wherein the door opening and closing device further comprises a suspension mechanism, the suspension mechanism comprising a suspension-connection member and a suspension-limit groove, the suspension-connection member being connected on the linkage gear, the suspension-limit groove being disposed on the base, the linkage gear being rotated to drive the suspension-connection member to be engaged with the suspension-limit groove, to prevent the door rotation mechanism from rotating the door body.

21. The refrigerator according to claim 19, wherein the suspension mechanism is connected between the linkage gear and the base, wherein when the linkage gear is rotated to a preset position, the suspension mechanism brakes the linkage gear on the base;
the suspension mechanism, a door ejection mechanism and the door rotation mechanism are located on a peripheral side of the linkage gear, the suspension mechanism and the door rotation mechanism being located on two sides of the door ejection mechanism.
